(19) United States
(12) Patent Application Publication
(10) Pub. No.: US 2023/0153737 A1
(43) Pub. Date: May 18, 2023

(54) METHOD AND DEVICE FOR EVALUATING EFFECTIVENESS OF TRANSFORMER FIRE EXTINGUISHING SYSTEM

(71) Applicants: STATE GRID ANHUI ELECTRIC POWER RESEARCH INSTITUTE, Hefei (CN); STATE GRID CORPORATION OF CHINA, Beijing (CN)

(72) Inventors: Jiaqing ZHANG, Hefei (CN); Fengju SHANG, Hefei (CN); Xiaodong ZHANG, Hefei (CN); Xinjie QIU, Hefei (CN); Dengfeng CHENG, Hefei (CN); Yifu ZHOU, Hefei (CN); Yi GUO, Hefei (CN); Yubiao HUANG, Hefei (CN); Wen SU, Hefei (CN); Rui LIU, Hefei (CN)

(73) Assignees: STATE GRID ANHUI ELECTRIC POWER RESEARCH INSTITUTE, Hefei (CN); STATE GRID CORPORATION OF CHINA, Beijing (CN)

(21) Appl. No.: 18/096,044

(22) Filed: Jan. 12, 2023

Related U.S. Application Data
(63) Continuation of application No. PCT/CN2022/096126, filed on May 31, 2022.

(30) Foreign Application Priority Data
May 11, 2021 (CN) 202110513627.7

(51) Int. Cl. G06Q 10/0639; G06Q 50/26

(52) U.S. Cl. CPC G06Q 10/06393; G06Q 50/265

(57) ABSTRACT

A method for evaluating the effectiveness of a transformer fire extinguishing system based on a natural language fuzzy analysis is provided, and a method and device for evaluating the fire extinguishing system are established. An expert fuzzy evaluation matrix is established by natural language fuzzifying and de-fuzzifying methods for the effectiveness of the fire extinguishing system. According to the relative influence of each index in the evaluation index system of the effectiveness of the fire extinguishing system, the weight comparison of each index is determined, and the index subjective weight is established based on the weight comparison of each index. A de-fuzzified matrix is obtained by de-fuzzifying an expert fuzzy evaluation matrix, and based on the de-fuzzified matrix, an objective weight is obtained by an entropy weight method. A comprehensive weight is obtained by combining the subjective and objective weights.

### CROSS REFERENCE TO THE RELATED APPLICATIONS

This application is a continuation application of International Application No. PCT/CN2022/096126, filed on May 31, 2022, which is based upon and claims priority to Chinese Patent Application No. 202110513627.7, filed on May 11, 2021, the entire contents of which are incorporated herein by reference.

### TECHNICAL FIELD

The present invention relates to the technical field of substation fire safety, particularly to a method and device for evaluating the effectiveness of a transformer fire extinguishing system.

### BACKGROUND

With the continuous development of the national economy and innovation of the construction industry in China, the demand for electricity is increasing, and the electric power industry is in a period of rapid development. The power system is made up of flammable and explosive equipment with high voltage, large current, and high energy storage, such as transformers, capacitors, power cables, and the like. If any of this equipment catches fire, it will pose a severe threat to the safe operation of the power system. Therefore, fire safety protection has great significance in working to avoid fire.

For the essential part of the power system in China, substations play a connecting role in the power transmission and transformation system. The substations are critical facilities for adjusting transmission voltage stably and effectively and accepting and distributing electric energy continuously and safely. During operation, the transformer is likely to catch fire under the conditions of severe overheating or internal short circuit fault, and the presence of insulating oil and insulation materials further increase the risk of fire, which will eventually cause severe losses to humans and damage the economy. As an essential part of substation facilities, the transformer fire extinguishing system must work reliably and effectively when there is a fire or explosion accident. Considering the requirement specification of the transformer and the conditions under which the transformer is being operated, the core of the design and selection of the transformer fire extinguishing system is based on how the system can be effectively put into use when needed. With the help of modern science and technology, the evaluation of the fire extinguishing system is also an important measure to prevent fire accidents and reflects effective fire extinguishing.

Since the process of the transformer catching fire is complex and the fire develops violently, it is crucial to implement an effective fire extinguishing evaluation system for different types of transformers in different environments. However, there are still some deficiencies in evaluating the fire extinguishing ability of the fire extinguishing system to extinguish the fires in transformers in prior fire extinguishing systems. It is difficult to select suitable transformer fire-preventing systems and fire-extinguishing systems for different environments. There are no comprehensive assessment methods for evaluating the effectiveness of fire extinguishing systems of different transformers operating under different conditions. It is imperative to put forward the methods and devices for evaluating the effectiveness of different transformer fire extinguishing systems.

The article “The Research On Fire Risk Assessment Based On Variable Weight Fuzzy Theory,” which was published in Vol 16, No. 12 of the journal Project Management Technology in December 2018 (Yan Zhang, Water Resources Faculty, North China University of Water Resources and Electric Power, Zhengzhou, Henan Province), disclosed that: “In the article, while using the analytic hierarchy process to determine the weight vector (constant weight vector), the idea of variable weight treatment is introduced, and the weight-varying process is further performed on the index weight value in the process of a fuzzy comprehensive evaluation of management level, so as to improve the scientificity and rationality of the evaluation result of the fire risk level.” In the article, the subjective weight of each index is determined by using the analytic hierarchy process, which is arbitrary, lacks objectivity, uses a complex process in subjective evaluation, and requires a high software operation level comparable to that of the expert.

### SUMMARY

The objective of the present invention is to provide a method for evaluating the effectiveness of a transformer fire extinguishing system, which is easy to operate and has low computational complexity. The method aims to address the technical problems in the prior art of the complex scoring operation process or the high requirements of expert computer skills in the process of evaluating the effectiveness of the transformer fire extinguishing system.

The present invention solves the technical problems by the following technical solutions:

The method for evaluating the effectiveness of the transformer fire extinguishing system based on a natural language fuzzy analysis includes the following steps:

Step 1: Collecting information, including: Collecting the design and operation information, surrounding environment information, and fire extinguishing system information of a substation. The information collected at least includes the design parameters of the fire extinguishing system, equipment operation data, maintenance, substation construction environment, and others.

Step 2: Constructing an effectiveness-evaluating index system of the fire extinguishing system, including: Classifying the factors that affect the fire extinguishing effectiveness of the fire extinguishing system, and constructing the effectiveness-evaluating system for the fire extinguishing system together with the factors.

Step 3: Establishing an index database, including: Configuring the effectiveness-evaluating system constructed as a candidate database, and compiling a corresponding evaluation table and a voice recognition database based on this database. The evaluation table is configured for expert to score directly, and the voice recognition database is configured for expert to input voice directly.

Step 4: Establishing an index natural language evaluation level, including: Determining the natural language evaluation level of the effectiveness-evaluating system of the fire extinguishing system, configuring the evaluation level as a voice evaluation level, expressing each evaluation level by a fuzzy number, and finally establishing a voice evaluation level database.

Step 5: Inputting a corresponding evaluation result by the expert. The input of the evaluation result includes the following two modes: (1) Configuring a form of text, including: Logging in to a WeChat mini program by the evaluation expert, initiating the input of the evaluation result, obtaining an evaluation table, writing the evaluation result into the evaluation table as required to submit, accepting the evaluation result in the evaluation table by a system, and establishing an expert fuzzy evaluation matrix. (2) Configuring a voice mode, including: Configuring a voice broadcast score item of the WeChat mini program, sending voice evaluation contents according to prompts by the expert, obtaining voice data by the WeChat mini program, performing a voice recognition based on a voice database, receiving preset voice input by the system to trigger corresponding evaluation indexes, endowing recognition results with the corresponding evaluation indexes, and establishing the expert fuzzy evaluation matrix.

Step 6: Determining an objective weight of the index, including: De-fuzzifying an expert fuzzy evaluation matrix to obtain an index scoring matrix, and determining an objective size of the index weight by an entropy weight method based on the index scoring matrix to obtain objective weights of different indexes.

Step 7: Establishing an index subjective weight scoring database, including: Establishing a subjective weight scoring table, determining a weight comparison of each index by the expert according to a relative influence of each index in the evaluation index system of the effectiveness of the fire extinguishing system, inputting a relative weight between the corresponding indexes, and finally establishing a subjective weight judgment matrix. The input of the subjective weight includes the following two modes: (1) Configuring a form of text, including: Logging in to a WeChat mini program by the evaluation expert, initiating the input of the evaluation result, obtaining an evaluation table, writing the evaluation result into the evaluation table as required to submit, accepting the evaluation result in the evaluation table by a system, and establishing the subjective weight judgment matrix, (2) Configuring a voice mode, including: Configuring a voice broadcast score item of the WeChat mini program, sending voice evaluation contents according to prompts by the expert, obtaining voice data by the WeChat mini program, performing a voice recognition based on a voice database, receiving preset voice input by the system to trigger corresponding evaluation indexes, endowing recognition results with the corresponding evaluation indexes, and establishing the subjective weight judgment matrix.

Step 8: Determining an index subjective weight, including: Performing a consistency test of the weight judgment matrix based on the establishment of an index relative weight judgment matrix. If the weight judgment matrix does not pass the consistency test, re-scoring and re-evaluating by the expert until passing the consistency test. Calculating the weight matrix which passed the consistency test to obtain the subjective weights of different indexes.

Step 9: Evaluating the effectiveness of the fire extinguishing system, including: Performing a comprehensive evaluation based on an effectiveness index. Performing a comprehensive evaluation according to the index scoring matrix and the average of the subjective and objective weight vectors, and determining an effectiveness level of the fire extinguishing system. If the effectiveness meets the requirements, completing the evaluation. If it does not meet the requirements, performing the rectification according to the solution measures and management suggestions put forward by the evaluation conclusions. After the rectification is completed, performing the re-evaluation until the evaluation result is acceptable.

The present invention adopts the technical solution described above and establishes a method and device for evaluating the fire extinguishing system. An expert fuzzy evaluation matrix is established by natural language fuzzifying and de-fuzzifying methods for the effectiveness of the fire extinguishing system. According to a relative influence of each index in the evaluation index system of the effectiveness of the fire extinguishing system, a weight comparison of each index is determined, and the index subjective weight is established based on this. A de-fuzzified matrix is obtained by de-fuzzifying an expert fuzzy evaluation matrix. Based on the de-fuzzified matrix, an objective weight is obtained by the entropy weight method. A comprehensive weight is obtained by combining the subjective and objective weights, and the index scoring matrix and the comprehensive weight are combined with each other to complete the comprehensive evaluation of the effectiveness of the transformer fire extinguishing system.

Further, in step 4, the specific process of establishing the index natural language evaluation level database includes: Establishing an evaluation set first according to the evaluation system, using five evaluation languages: “excellent,” “good,” “general,” “poor,” and “very poor,” and recording the evaluation language level as L4-L0 in turn, expressing and describing the evaluation set by natural language fuzzy numbers, and setting the evaluation set as V={excellent, good, general, poor, very poor}. Supposing that M experts are involved in the evaluation of the effectiveness of the transformer fire extinguishing system, supposing that the k^{th} expert evaluates the i^{th} evaluation index as an evaluation level value xᵢₖ, and performing the natural language fuzzification on the effectiveness of the evaluation index of the transformer fire extinguishing system. The natural language fuzzifying function ƒ(xᵢₖ) is:

$$f ( {x}_{ik} ) = \{ \begin{matrix}\frac{{x}_{ik} - l}{m - l} & {x}_{ik} ∈ [ l , m ] \\ \frac{u - {x}_{ik}}{u - m} & {x}_{ik} ∈ [ m , u ] \\ 0 & {x}_{ik} ∈ ( - ∞ , l ) ⋃ ( u , + ∞ )\end{matrix}$$

The function ƒ(xᵢₖ) represents the natural language fuzzifying function of the k^{th} expert to the i^{th} evaluation index. Supposing that the language level evaluation fuzzy matrix of the k^{th} expert to the evaluation index is V=[νᵢₖ]. The natural language fuzzifying function is νᵢₖ=(νᵢₖ₁, νᵢₖ₂, νᵢₖ₃) in form. Obtaining ν̅ᵢₖ=(ν̅ᵢₖ₁, ν̅ᵢₖ₂, ν̅ᵢₖ₃) by averaging all the expert fuzzy evaluation matrices.

Further, in step 6, de-fuzzifying a fuzzy comprehensive evaluation system of the effectiveness of the converter transformer fire extinguishing system by using a formula of

$${F}_{3} ( V ) = \frac{{v}_{1} + 2 {v}_{2} + {v}_{3}}{4}$$

to obtain a de-fuzzified evaluation matrix V of the comprehensive evaluation of the effectiveness of the transformer fire extinguishing system, and obtaining an information entropy by using a formula

$${e}_{i} = - \frac{1}{ln n} {\sum }_{j = 1}^{n} ( \frac{{b}_{ij}}{{\sum }_{j = 1}^{n} {b}_{i}} ) ln ( \frac{{b}_{ij}}{{\sum }_{j = 1}^{n} {b}_{i}} )$$

based on the de-fuzzified evaluation matrix V, where eᵢ denotes the information entropy, and bᵢ denotes a de-fuzzified evaluation value of the index.

Obtaining an entropy weight and a row vector W_{β}=(w₁, w₂, . . . , wₙ)^{T} by using a formula

$${w}_{i} = \frac{1 - {e}_{i}}{m - {\sum }_{i = 1}^{m} {e}_{i}} ,$$

where the wᵢ denotes the weight, the W_{β}=(w₁, w₂, . . . , wₙ)^{T} denotes an objective entropy weight vector requested.

Further, in step 7, according to each index in the effectiveness of the transformer fire extinguishing system, the specific process of obtaining the interaction between the index and other indexes includes: Establishing an evaluation judgment matrix U for the effectiveness of the converter substation fire extinguishing system according to the relative importance of each index to other indexes by a certain scale to obtain the interaction between the index and other indexes, inputting relative weights between the corresponding indexes by the expert, and finally establishing a subjective weight judgment matrix. The subjective weight judgment matrix is shown such as Table 1.

TABLE 1
subjective weight judgment matrix

| Uᵢ | U₁ | U₁ | . . . | U₁ₙ |
|---|---|---|---|---|
| U₁ | u₁₁ | u₁₂ | . . . | u₁ₙ |
| U₂ | u₂₁ | u₂₂ | . . . | u₂ₙ |
| . . . | . . . | . . . | . . . | . . . |
| Uₙ | uₙ₁ | uₙ₂ | . . . | uₙₙ |

Further, in step 8, the process of calculating the subjective weight vector includes: Normalizing the judgment matrix U by column by using a formula

$${\overline{u}}_{ij} = \frac{{u}_{ij}}{{\sum }_{k = 1}^{n} {u}_{kj}} , ( i , j = 1 , 2 , … n )$$

based on the evaluation judgment matrix U for the effectiveness of the converter substation fire extinguishing system to obtain a matrix Ū=[ū₁ⱼ, ū₂ⱼ, . . . , ūₙⱼ], where uᵢⱼ represents the influence of the i^{th} factor on the j^{th} factor.

Adding the normalized judgment matrix Ū by row by using a formula

$${\overline{W}}_{i} = {\sum }_{j = 1}^{n} {\overline{u}}_{ij} , ( i , j = 1 , 2 , … n ) .$$

Normalizing the matrix W̅ᵢ added by row by using a formula

$${w}_{i} = \frac{{\overline{W}}_{i}}{{\sum }_{j = 1}^{n} {\overline{W}}_{j}} , ( i = 1 , 2 , … n )$$

to obtain a row vector W_{α}=(w₁, w₂, . . . , wₙ)^{T}, W_{α}=(w₁, w₂, . . . , wₙ)^{T} denotes the subjective weight vector requested.

Further, in step 8, the process of the consistency test of the expert matrix includes: Calculating a maximum eigenvalue Amax of an expert judgment matrix and an expert weighting matrix. Calculating the consistency test index of the expert judgment matrix by using a formula

$$CI = \frac{{λ}_{max} - n}{n - 1}$$

according to the maximum eigenvalue, where n denotes an order of the matrix. If the consistency test index is less than a set value, judging the expert judgment matrix to meet the requirements and pass the consistency test. If the consistency test index is not less than the set value, judging the expert judgment matrix to not pass the consistency test, and continuing to adjust the value of the elements in the expert judgment matrix until the expert judgment matrix passes the consistency test.

Further, in step 9, averaging the calculated subjective and objective weights to obtain a final comprehensive weight vector expressed as W=(w₁, w₂, . . . , wₙ)^{⋅}. Performing a point multiplication between the de-fuzzified evaluation matrix V and the comprehensive weight vector W to obtain a final evaluation score. Determining an effectiveness level of the fire extinguishing system. If the effectiveness meets the requirements, completing the evaluation. If it does not meet the requirements, performing the rectification according to the solution measures and management suggestions put forward by the evaluation conclusions. After the rectification is completed, performing the re-evaluation until the evaluation result is acceptable.

The present invention further provides a device for evaluating the effectiveness of the transformer fire extinguishing system based on the natural language fuzzy analysis, including:

An index system establishment module (ISEM) for the effectiveness of the fire extinguishing system, configured for: Selecting the characteristics of factors that affect the fire extinguishing effectiveness of the fire extinguishing system, establishing an effectiveness index system of the fire extinguishing system, configuring the established effectiveness-evaluating system as the candidate database, compiling the corresponding evaluation table and the voice recognition database based on this database, determining the natural language evaluation level of the effectiveness-evaluating system of the fire extinguishing system, configuring the evaluation level as the voice evaluation level, expressing each evaluation level by fuzzy number, and finally establishing a voice evaluation level database.

An index scoring module (ISM) for the fire extinguishing effectiveness, configured for: Inputting the evaluation level results of the corresponding indexes and the subjective weight judgment matrix by the expert. The input of the evaluation result includes the following two modes: (1) Configuring a form of text. Logging in to a WeChat mini program by the evaluation expert, initiating the input of the evaluation result, obtaining an evaluation table, writing the evaluation result into the evaluation table as required to submit, accepting the evaluation result in the evaluation table by a system, and establishing the expert fuzzy evaluation matrix. (2) Configuring a voice mode. Configuring a voice broadcast score item of the WeChat mini program, sending voice evaluation contents according to prompts by the expert, obtaining voice data by the WeChat mini program, performing a voice recognition based on a voice database, receiving preset voice input by the system to trigger corresponding evaluation indexes, endowing recognition results with the corresponding evaluation indexes, and establishing the expert fuzzy evaluation matrix.

An index comprehensive weight calculation module (IWCM) for the fire extinguishing effectiveness, configured for: Determining the subjective and objective weights of each index in the effectiveness-evaluating index system of the fire extinguishing system, that is, de-fuzzifying the index evaluation matrix, determining the objective size of the index weight by using an entropy weight method to obtain objective weights of different indexes, determining the weight comparison of each index according to the relative influence of each index, obtaining the subjective weight judgment matrix of relative importance according to the correlation of indexes, and performing the consistency test of the subjective weight judgment matrix. After the subjective weight judgment matrix passes the consistency test, performing a calculation according to the subjective weight and the objective weight to obtain the subjective weights of different indexes.

An effectiveness-evaluating module (EEM) for the fire extinguishing, configured for: Evaluating the effectiveness of the transformer fire extinguishing system according to an index scoring matrix and a comprehensive weight. Determining the effectiveness level of the fire extinguishing system. According to the evaluation result, if the effectiveness meets the requirements, completing the evaluation. If it does not meet the requirements, performing the rectification according to the solution measures and management suggestions put forward by the evaluation conclusions. After the rectification is completed, preforming a re-evaluation by returning to step 3 until the evaluation result is acceptable.

Further, in the ISM, the process of establishing the expert fuzzy evaluation matrix includes: Establishing the evaluation set first according to the evaluation system. Using five evaluation languages: “excellent,” “good,” “general,” “poor,” and “very poor,” and recording the evaluation language level as L4-L0 in turn. Performing the natural language fuzzification on the effectiveness of the evaluation index of the transformer fire extinguishing system. The natural language fuzzifying function ƒ(xᵢₖ) is

$$f ( {x}_{ik} ) = \{ \begin{matrix}\frac{{x}_{ik} - l}{m - l} & {x}_{ik} ∈ [ l , m ] \\ \frac{u - {x}_{ik}}{u - m} & {x}_{ik} ∈ [ m , u ] \\ 0 & {x}_{ik} ∈ ( - ∞ , l ) ⋃ ( u , + ∞ )\end{matrix} ,$$

where the function ƒ(xᵢₖ) represents the natural language fuzzifying function of the k^{th} expert to the i^{th} evaluation index.

In the EEM, the language level evaluation fuzzy matrix of the k^{th} expert to the evaluation index is supposed to be V=[νᵢₖ], where the natural language fuzzifying function is νᵢₖ=(νᵢₖ₁, νᵢₖ₂, νᵢₖ₃) in form, and all the expert fuzzy evaluation matrices are averaged to obtain ν̅ᵢₖ=(ν̅ᵢₖ₁, ν̅ᵢₖ₂, ν̅ᵢₖ₃).

Further, in the IWCM, the fuzzy comprehensive evaluation system of the effectiveness of the converter transformer fire extinguishing system is de-fuzzified by using the formula of

$${F}_{3} ( V ) = \frac{{v}_{1} + 2 {v}_{2} + {v}_{3}}{4}$$

to obtain the de-fuzzified matrix V of the comprehensive evaluation of the effectiveness of the transformer fire extinguishing system. The information entropy is obtained by using the formula

$${e}_{i} = - \frac{1}{ln n} {\sum }_{j = 1}^{n} ( \frac{{b}_{ij}}{{\sum }_{j = 1}^{n} {b}_{i}} ) ln ( \frac{{b}_{ij}}{{\sum }_{j = 1}^{n} {b}_{i}} )$$

based on the de-fuzzified evaluation matrix, where eᵢ denotes the information entropy, and bᵢ denotes a de-fuzzified evaluation value of the index. An entropy weight and a vector W_{β}=(w₁, w₂, . . . , wₙ)^{T} are obtained by using a formula

$${w}_{i} = \frac{1 - {e}_{i}}{m - {\sum }_{i = 1}^{m} {e}_{i}} ,$$

where the wᵢ denotes the objective weight, the W_{β}=(w₁, w₂, . . . , wₙ)^{T} denotes an objective weight vector requested.

In the IWCM, the process of calculating the subjective weight vector includes: Normalizing the judgment matrix U by column by using the formula

$${\overline{u}}_{ij} = \frac{{u}_{ij}}{{\sum }_{k = 1}^{n} {u}_{kj}} , ( i , j = 1 , 2 , … n )$$

based on the evaluation judgment matrix U for the effectiveness of the converter substation fire extinguishing system to obtain the matrix Ū=[ū₁ⱼ, ū₂ⱼ, . . . , ūₙⱼ], where uᵢⱼ where uᵢⱼ represents the influence of the i^{th} factor on the j^{th} factor.

Adding the normalized judgment matrix Ū by row by using the formula

$${\overline{W}}_{i} = {\sum }_{j = 1}^{n} {\overline{u}}_{ij} , ( i , j = 1 , 2 , … n ) .$$

Normalizing the matrix W̅ᵢ added by row by using the formula

$${w}_{ij} = \frac{{\overline{W}}_{i}}{{\sum }_{j = 1}^{n} {\overline{W}}_{j}} , ( i = 1 , 2 , … n )$$

to obtain a row vector W=(w₁, w₂, . . . , wₙ)^{T}, W=(w₁, w₂, . . . , wₙ)^{T} denotes the subjective weight vector requested.

Further, the risk assessment in the EEM includes: Averaging the calculated subjective and objective weights to obtain a final comprehensive weight vector expressed as W=(w₁, w₂, . . . , wₙ)^{⋅}. Performing a point multiplication between the de-fuzzified matrix V and the comprehensive weight vector W to obtain the final evaluation score. Determining the effectiveness level of the fire extinguishing system. If the effectiveness meets the requirements, completing the evaluation. If it does not meet the requirements, performing the rectification according to the solution measures and management suggestions put forward by the evaluation conclusions. After the rectification is completed, performing the re-evaluation until the evaluation result is acceptable, and completing the comprehensive evaluation of the effectiveness of the transformer fire extinguishing system.

The present invention has the following advantages:

The object of the present invention is to provide a method and device for evaluating a transformer fire extinguishing system, which should be comprehensive and concise and have high reliability and strong stability to determine the fire extinguishing effectiveness of the fire extinguishing system. The method establishes effectiveness-evaluating criteria and provides a basis for evaluating the fire extinguishing system. The present invention uses natural language for scoring and uses fuzzy numbers and defuzzification for analysis and processing, which reduces the complexity of scoring and the difficulty of data processing and makes the evaluation process more concise. The scoring mode is configured with manual input and voice input, which are more friendly to an expert who is not adept at using the smartphone or computers.

The present invention adopts the technical solution described above to establish a method and device for evaluating the fire extinguishing system. An expert fuzzy evaluation matrix is established by natural language fuzzifying and de-fuzzifying methods on the effectiveness of the fire extinguishing system. According to the relative influence of each index in the evaluation index system on the effectiveness of the fire extinguishing system, the weight comparison of each index is determined, and the index subjective weight is established based on the weight comparison of each index. A de-fuzzified matrix is obtained by de-fuzzifying an expert fuzzy evaluation matrix. Based on the de-fuzzified matrix, an objective weight is obtained by entropy weight method. A comprehensive weight is obtained by combining the subjective and objective weights. The index scoring matrix and the comprehensive weight are combined with each other to complete the comprehensive evaluation of the effectiveness of the transformer fire extinguishing system.

By classifying the factors that affect the fire extinguishing effectiveness of the fire extinguishing system, the evaluation index system of the transformer fire extinguishing system is constructed. The natural language fuzzifying and de-fuzzifying methods of the effectiveness of the fire extinguishing system are established. The evaluation level results of the corresponding indexes are input by the expert by voice or text. The expert fuzzy evaluation matrix is established. The objective size of the index weight is determined by using the entropy method to obtain the objective weights of different indexes. A subjective weight size of each index is determined according to a relative influence of each index in the evaluation index system of the effectiveness of the fire extinguishing system. A subjective judgment matrix of the corresponding indexes is input by the expert in the form of voice or text. Based on the subjective and objective weights, the index comprehensive weight is established. By combining the index scoring matrix and the index comprehensive weight, the final evaluation score is obtained. The effectiveness level of the fire extinguishing system is determined, and the comprehensive evaluation of the transformer fire extinguishing system is completed.

### BRIEF DESCRIPTION OF THE DRAWINGS

FIG. 1 is a flow chart of a method for evaluating the effectiveness of a transformer fire extinguishing system provided by Embodiment I of the present invention.

FIG. 2 is a schematic diagram showing a structure of a device for evaluating the effectiveness of a transformer fire extinguishing system provided by Embodiment II of the present invention.

### DETAILED DESCRIPTION OF THE EMBODIMENTS

To make the purpose, technical solution, and advantages of the embodiments of the present invention clear, the technical solutions in the embodiments of the present invention will be clearly and completely described in the following description in combination with the embodiments of the present invention. Obviously, the described embodiments are part of the embodiments of the present invention and are not all embodiments. Based on the embodiments of the present invention, all other embodiments obtained by one of ordinary skill in the art without creative work shall fall within the scope of the protection of the present invention.

### Embodiment I

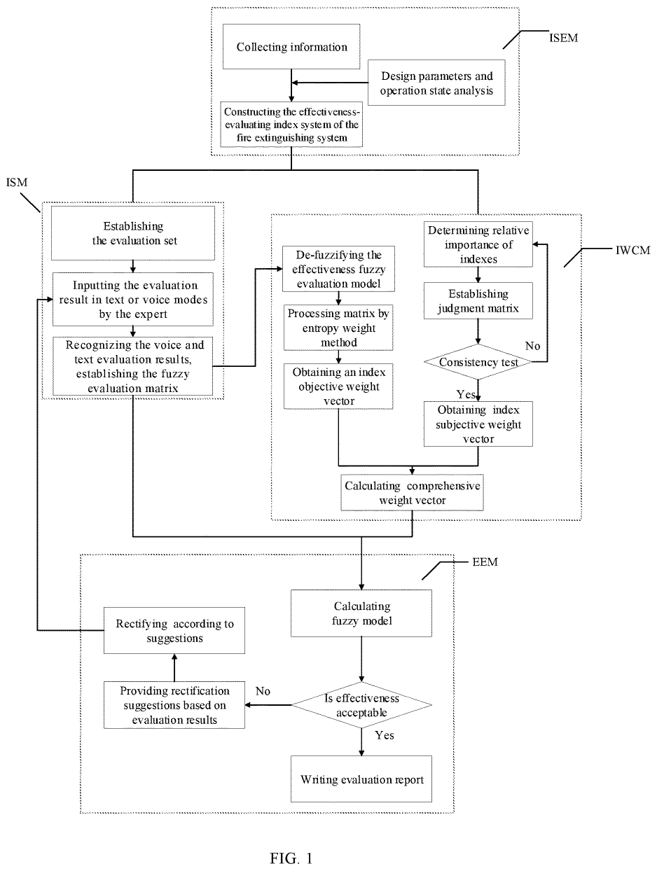

FIG. 1 is a schematic diagram of a method for evaluating the effectiveness of a transformer fire extinguishing system based on a natural language fuzzy analysis provided by an embodiment of the present invention. As shown in FIG. 1, the method includes:

Step 1: The design parameters of the fire extinguishing system, equipment operation data, maintenance, substation construction environment, and other information are collected.

Step 2: An effectiveness-evaluating index system of the transformer fire extinguishing system is constructed. The main indexes that affect the fire extinguishing effectiveness of the transformer fire extinguishing system are selected to form an evaluation index system. The main indexes include four first-level indexes for effectiveness: “fire extinguishing agent index,” “fire extinguishing performance index,” “fire extinguishing pertinence index,” and “fire extinguishing safety index.” Based on the literature review and analysis, the factors that affect the first-level indexes are selected to form corresponding second-level indexes. The first-level indexes and the second-level indexes are used to construct the effectiveness-evaluating system of the transformer fire extinguishing system. Table 2 is the effectiveness-evaluating system of the transformer fire extinguishing system constructed in Embodiment I of the present invention.

TABLE 2
Effectiveness-evaluating system of the
transformer fire extinguishing system

| First-level index | Second-level index |
|---|---|
| Fire extinguishing agent | Fire extinguishing agent reserves B₁ |
| index A₁ | Fire extinguishing agent fluidity B₂ |
| | Fire resistance of fire extinguishing agent |
| | B₃ |
| | Fire isolation performance of fire |
| | extinguishing agent B₄ |
| Fire extinguishing | The response speed of fire protection |
| performance index A₂ | system B₅ |
| | Smoke control ability B₆ |
| | Fire control range B₇ |
| | Fire extinguishing speed B₈ |
| | Sustainable working time of fire protection |
| | system B₉ |
| | The cooling effect of ambient temperature |
| | B₁₀ |
| Fire extinguishing | Minimum operating temperature B₁₁ |
| pertinence index A₃ | Applicability of water source B₁₂ |
| | Applicability of protected objects B₁₃ |
| Fire extinguishing safety | Human safety in fire extinguishing B₁₄ |
| index A₄ | Impact on the environment after fire |
| | extinguishing B₁₅ |
| | Impact on equipment after fire |
| | extinguishing B₁₆ |

Step 3: An index database is established. The constructed effectiveness-evaluating system is configured as a candidate database, and a corresponding evaluation table and a voice recognition database are compiled based on this database. The evaluation table is configured for an expert to score directly, and the voice recognition database is configured for an expert to input voice directly.

For example, Table 3 is a natural language scoring matrix for the effectiveness of the transformer fire extinguishing system.

TABLE 3
Expert natural language scoring matrix for effectiveness
index of the transformer fire extinguishing system
Natural language scoring table, divided into {excellent, good, general, poor, very poor}

| Fire | | | | | | | | | | Fire | | | Fire | | |
|---|---|---|---|---|---|---|---|---|---|---|---|---|---|---|---|
| extinguishing | | | | Fire extinguishing | | | | | | extinguishing | | | extinguishing | | |
| agent index | | | | performance index | | | | | | pertinence index | | | safety index | | |
| B₁ | B₂ | B₃ | B₄ | B₅ | B₆ | B₇ | B₈ | B₉ | B₁₀ | B₁₁ | B₁₂ | B₁₃ | B₁₄ | B₁₅ | B₁₆ |

Expert
1
Expert
2
Expert
3
Expert
4

Step 4: An index natural language evaluation level is established. A natural language evaluation level of the effectiveness-evaluating system of the fire extinguishing system is determined. The evaluation level is configured as a voice evaluation level. Each evaluation level is expressed by a fuzzy number. Finally, a voice evaluation level database is established.

TABLE 4
Natural language fuzzifying function

| Language evaluation | | Natural language |
|---|---|---|
| level | Meaning and Symbol | fuzzifying function |
| L4 | excellent | (0.75, 1.00, 1.00) |
| L3 | good | (0.50, 0.75, 1.00) |
| L2 | general | (0.25, 0.50, 0.75) |
| L1 | poor | (0, 0.25, 0.50) |
| L0 | very poor | (0, 0, 0.25) |

All the expert fuzzy evaluation matrices are averaged to obtain ν̅ᵢₖ=(ν̅ᵢₖ₁, ν̅ᵢₖ₂, ν̅ᵢₖ₃).

Step 5: A corresponding evaluation result is an input by the expert. The input of the evaluation result includes the following two modes: (1) A form of text is configured. A WeChat mini program is logged in by the evaluation expert, the input of the evaluation result is initiated, an evaluation table is obtained, and the evaluation result is written into the evaluation table as required to submit. The evaluation result in the evaluation table are accepted by the system, and the expert fuzzy evaluation matrix is established. (2) A voice mode is configured. A voice broadcast score item of the WeChat mini program is configured. Voice evaluation contents are sent by the expert according to prompts, voice data is obtained by the WeChat mini program, and a voice recognition is performed based on a voice database. Preset voice input is received by the system to trigger corresponding evaluation indexes, recognition results are endowed with the corresponding evaluation indexes, and the expert fuzzy evaluation matrix is established.

Step 6: An objective weight of the index for effectiveness is determined. The expert fuzzy evaluation matrix is de-fuzzified to obtain an index scoring matrix. An objective size of the index weight is determined by an entropy weight method based on the index scoring matrix, and objective weights of different indexes are obtained. A fuzzy comprehensive evaluation matrix of the effectiveness of the converter transformer fire extinguishing system is de-fuzzified by using a formula of

$${F}_{3} ( H ) = \frac{{e}_{1} + 2 {e}_{2} + {e}_{3}}{4}$$

through the expert fuzzy evaluation matrix ν̅ᵢₖ to obtain a de-fuzzified matrix V of the comprehensive evaluation of the effectiveness of the transformer fire extinguishing system.

Information entropy represents the degree of information confusion of the index. When the entropy value decreases, the information is more ordered, and when the entropy value increases, the information is more disordered. The information entropy is obtained by using a formula

$${e}_{i} = - \frac{1}{ln n} {\sum }_{j = 1}^{n} ( \frac{{b}_{ij}}{{\sum }_{j = 1}^{n} {b}_{i}} ) ln ( \frac{{b}_{ij}}{{\sum }_{j = 1}^{n} {b}_{i}} )$$

based on the de-fuzzified evaluation matrix. eᵢ denotes the information entropy, and bᵢ denotes a de-fuzzified evaluation value of the index. An entropy weight and a row vector W_{β}=(w₁, w₂, . . . , wₙ)^{T} are obtained by using a formula

$${w}_{i} = \frac{1 - {e}_{i}}{m - {\sum }_{i = 1}^{m} {e}_{i}} .$$

wᵢ denotes the objective weight, and W_{β}=(w₁, w₂, . . . , wₙ)^{T} denotes an objective entropy weight vector requested.

A natural language fuzzification is performed on the effectiveness of the evaluation index of the transformer fire extinguishing system. The processing function is shown in Table 4, and the fuzzy evaluation matrix is obtained.

Step 7: An index subjective weight voice scoring database is established. A subjective weight scoring table is established, and a weight comparison of each index is determined by the expert according to a relative influence of each index in the effectiveness-evaluating index system of the fire extinguishing system. Relative weights between the corresponding indexes are voice-input, and finally, a subjective weight judgment matrix is established. The input of the subjective weight includes the following two modes: (1) A form of text is configured. A WeChat mini program is logged in by the evaluation expert, the input of the evaluation result is initiated, an evaluation table is obtained, and the evaluation result is written into the evaluation table as required to submit. The evaluation result in the evaluation table is accepted by the system, and the subjective weight judgment matrix is established. (2) A voice mode is configured. A voice broadcast score item of the WeChat mini program is configured. Voice evaluation contents are sent by the expert according to prompts, voice data is obtained by the WeChat mini program, and a voice recognition is performed based on a voice database. Preset voice input is received by the system to trigger corresponding evaluation indexes, recognition results are endowed with the corresponding evaluation indexes, and the subjective weight judgment matrix is established.

For example, Tables 5 and 6 are scoring tables for the subjective weight of the effectiveness of the fire extinguishing system by the expert.

TABLE 5
Subjective weight judgment scoring table of the first-level indexes
(Judging the relative size of the index subjective
weight according to the index scale 1 to 9)

| | | | |
|---|---|---|---|
| A₁ | A₂ | A₃ | A₄ |

A₁
A₂
A₃
A₄

TABLE 6
Subjective weight judgment scoring table of the second-level indexes
(Judging the relative size of the index subjective weight according to the index scale 1 to 9)

| | Fire | | | | | | | | | | Fire | | | Fire | | |
|---|---|---|---|---|---|---|---|---|---|---|---|---|---|---|---|---|
| | extinguishing | | | | Fire extinguishing | | | | | | extinguishing | | | extinguishing | | |
| Index | agent index | | | | performance index | | | | | | pertinence index | | | safety index | | |
| degree | B₁ | B₂ | B₃ | B₄ | B₅ | B₆ | B₇ | B₈ | B₉ | B₁₀ | B₁₁ | B₁₂ | B₁₃ | B₁₄ | B₁₅ | B₁₆ |

B₁
B₂
B₃
B₄
B₅
B₆
B₇
B₈
B₉
B₁₀
B₁₁
B₁₂
B₁₃
B₁₄
B₁₅
B₁₆

Step 8: The index subjective weight is determined. A consistency test of the weight judgment matrix is performed based on the establishment of an index relative weight judgment matrix. If the weight judgment matrix does not pass the consistency test, it will be re-scored and re-evaluated by the expert until passing the consistency test. The weight matrix which passed the consistency test is calculated to obtain the subjective weights of the different indexes.

The process of the consistency test of the expert matrix includes: A maximum eigenvalue λₘₐₓ of the expert judgment matrix and an expert weighting matrix are calculated. According to the maximum eigenvalue, the consistency test index of the expert judgment matrix is calculated by using a formula

$$CI = \frac{{λ}_{max} - n}{n - 1} ,$$

where n denotes an order of the matrix.

If the consistency test index is less than a set value, the expert judgment matrix is judged to meet the requirements and pass the consistency test.

If the consistency test index is not less than the set value, the expert judgment matrix is judged to not pass the consistency test, and the value of the elements in the expert judgment matrix should be adjusted until the expert judgment matrix passes the consistency test.

Step 9: Fire extinguishing effectiveness is evaluated. The calculated subjective and objective weights are averaged to obtain a final comprehensive weight vector expressed as W=(w₁, w₂, . . . , wₙ)^{⋅}. A point multiplication is performed between the de-fuzzified matrix V and the comprehensive weight vector W to obtain a final evaluation score, and an effectiveness level of the fire extinguishing system is determined. If the effectiveness meets the requirements, the evaluation will be completed. If the effectiveness does not meet the requirements, the rectification will be performed according to the solution measures and management suggestions put forward by the evaluation conclusions. After the rectification is completed, a re-evaluation will be performed by returning to step 3 until the evaluation result is acceptable.

The method for evaluating the effectiveness of the fire extinguishing system includes:

A form of text is configured. The WeChat mini program is logged in by the evaluation expert, an evaluation table is obtained, and the evaluation table is filled in to submit; or

(2) A voice mode is configured. For the expert who is not good with the smartphone or computer, a WeChat mini program voice broadcast score item is configured. Voice evaluation contents are sent by the expert according to prompts, and the WeChat mini program automatically converts the voice message into the evaluation result.

### Embodiment II

The present invention further provides a device for evaluating the effectiveness of the transformer fire extinguishing system corresponding to Embodiment I as shown in FIG. 1 of the present invention.

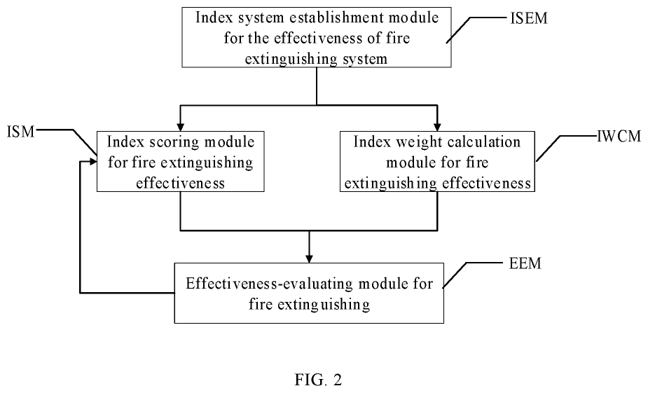

FIG. 2 is a schematic diagram showing the structure of the device for evaluating the effectiveness of the transformer fire extinguishing system provided by the embodiment of the present invention. As shown in FIG. 2, the device includes:

An index system establishment module (ISEM) for the effectiveness of the fire extinguishing system: In the ISEM, the characteristics of factors that affect the fire extinguishing effectiveness of the fire extinguishing system are selected. An effectiveness index system of the fire extinguishing system is established. The characteristics of the factors include the design parameters of the fire extinguishing system, equipment operation data, maintenance, substation construction environment, and others. The constructed effectiveness-evaluating system is configured as the candidate database. The corresponding evaluation table and the voice recognition database are compiled based on this database. The natural language evaluation level of the effectiveness-evaluating system of the fire extinguishing system is determined. The evaluation level is configured as the voice evaluation level. Each evaluation level is expressed by the fuzzy number. Finally, the voice evaluation level database is established.

An index scoring module (ISM) for the fire extinguishing effectiveness: The evaluation level results of the corresponding indexes and the subjective weight judgment matrix are input by the expert. The input of the evaluation result includes the following two modes: (1) The form of text is configured. The WeChat mini program is logged in by the evaluation expert, the input of the evaluation result is initiated, the evaluation table is obtained, and the evaluation result is written into the evaluation table as required to submit. The evaluation result in the evaluation table is accepted by the system, and the expert fuzzy evaluation matrix is established. (2) A voice mode is configured. A voice broadcast score item of the WeChat mini program is configured. Voice evaluation contents are sent by the expert according to prompts, voice data is obtained by the WeChat mini program, and voice recognition is performed based on a voice database. Preset voice input is received by the system to trigger corresponding evaluation indexes, recognition results are endowed with the corresponding evaluation indexes, and the expert fuzzy evaluation matrix is established.

An index weight calculation module (IWCM) for the fire extinguishing effectiveness: IWCM is configured for determining the subjective and objective weights of each index in the effectiveness-evaluating index system of the fire extinguishing system (i.e., de-fuzzifying the index evaluation matrix), determining the objective size of the index weight by using an entropy weight method to obtain objective weights of different indexes, determining the subjective weight comparison of each index according to the relative influence of each index in the effectiveness-evaluating index system of the fire extinguishing system, (i.e., the correlation of indexes), obtaining the subjective weight judgment matrix of relative importance according to the correlation of indexes, performing the consistency test of the subjective weight judgment matrix, and performing a calculation according to the subjective weight judgment matrix after the weight judgment matrix passes the consistency test to obtain the subjective weights of different indexes.

An effectiveness-evaluating module (EEM) for the fire extinguishing: EEM is configured for evaluating the effectiveness of the transformer fire extinguishing system according to the index scoring matrix and a comprehensive weight and determining the effectiveness level of the fire extinguishing system. According to the evaluation result, if the effectiveness meets the requirements, the evaluation will be completed. If the effectiveness does not meet the requirements, the rectification will be performed according to the solution measures and management suggestions put forth by the evaluation conclusions, and the re-evaluation will be performed until the evaluation result is acceptable.

By applying the embodiment shown in FIG. 2 of the present invention, the method and device for evaluating the fire extinguishing system are established. By classifying the factors that affect the effectiveness of the fire extinguishing system, the evaluation index system of the whole transformer fire extinguishing system is established. The natural language fuzzifying and de-fuzzifying methods of the effectiveness of the fire extinguishing system are determined. The evaluation result is input in text or voice modes by the expert, the expert fuzzy evaluation matrix is established, and the objective size of the index weight is determined by the entropy weight method to obtain objective weights of different indexes. The comprehensive weight is obtained by combining the subjective and objective weights, and the index scoring matrix and the comprehensive weight are combined to complete the comprehensive evaluation of the transformer fire extinguishing system.

For example:

In the ISEM,

the characteristics of factors that affect the fire extinguishing effectiveness of the fire extinguishing system are selected according to the literature review or based on field investigation and other modes, and the effectiveness index system of the fire extinguishing system is established. The selected results of the effectiveness-evaluating index of the transformer fire extinguishing system are shown in Table 1 of Embodiment I;

the constructed effectiveness-evaluating system is configured as a candidate database, and a corresponding evaluation table and a voice recognition database are compiled based on this database. The evaluation table is configured for an expert to score directly, and the voice recognition database is configured for an expert to input voice directly;

the natural language evaluation level of the effectiveness-evaluating system of the fire extinguishing system is determined. The evaluation level is configured as the voice evaluation level. Each evaluation level is expressed by the fuzzy number. Finally, the voice evaluation level database is established.

The ISM is configured for determining the natural language fuzzifying method for the effectiveness of the fire extinguishing system and inputting the evaluation level results of the corresponding indexes and the subjective weight judgment matrix by the expert. The input of the evaluation result includes the following two modes: (1) A form of text is configured. A WeChat mini program is logged in by the evaluation expert, the input of the evaluation result is initiated, an evaluation table is obtained, the evaluation result is written into the evaluation table as required to submit, the evaluation result in the evaluation table is accepted by a system, and the expert fuzzy evaluation matrix is established. (2) A voice mode is configured. A voice broadcast score item of the WeChat mini program is configured, voice evaluation contents are sent by the expert according to prompts, voice data is obtained by the WeChat mini program, voice recognition is performed based on a voice database, preset voice input is received by the system to trigger corresponding evaluation indexes, recognition results are endowed with the corresponding evaluation indexes, and the expert fuzzy evaluation matrix is established.

The characteristics of factors of the effectiveness of the transformer fire extinguishing system selected by the ISEM can be used as the evaluation index.

The evaluation set can be divided into five evaluation languages, such as “excellent,” “good,” “general,” “poor,” and “very poor,” which respectively correspond to evaluation language level L4-L0. The expert natural language scoring table for the effectiveness index of the transformer fire extinguishing system is shown in Table 4 of Embodiment I. According to the expert natural language scoring table of the effectiveness index of the transformer fire extinguishing system, a natural language fuzzification is performed on the effectiveness of the evaluation index of the transformer fire extinguishing system, and all the expert fuzzy evaluation matrices are averaged by using the natural language fuzzifying function νᵢₖ=(νᵢₖ=(νᵢₖ₁, νᵢₖ₂, νᵢₖ₃) to obtain ν̅ᵢₖ=(ν̅ᵢₖ₁, ν̅ᵢₖ₂, ν̅ᵢₖ₃).

The IWCM is configured for the objective weight vector calculation process.

The formula

$${F}_{3} ( V ) = \frac{{v}_{1} + 2 {v}_{2} + {v}_{3}}{4}$$

is used to de-fuzzify the fuzzy comprehensive evaluation system of the effectiveness of the converter transformer fire extinguishing system to obtain the de-fuzzified matrix V for the comprehensive evaluation of the effectiveness of the transformer fire extinguishing system.

The information entropy is obtained by using the formula

$${e}_{i} = - \frac{1}{ln n} {\sum }_{j = 1}^{n} ( \frac{{b}_{ij}}{{\sum }_{j = 1}^{n} {b}_{i}} ) ln ( \frac{{b}_{ij}}{{\sum }_{j = 1}^{n} {b}_{i}} )$$

based on the de-fuzzified evaluation matrix, where eᵢ denotes the information entropy, and bᵢ denotes a de-fuzzified evaluation value of the index.

An entropy weight and a row vector W_{β}=(w₁, w₂, . . . , wₙ)^{T} are obtained by using a formula

$${w}_{i} = \frac{1 - {e}_{i}}{m - {\sum }_{i = 1}^{m} {e}_{i}} ,$$

where the wᵢ denotes the objective weight, and the W_{β}=(w₁, w₂, . . . , wₙ)^{T} denotes an objective entropy weight vector requested.

According to the effectiveness-evaluating index of the fire extinguishing system, an expert scoring table for the relative influence of each index in the effectiveness-evaluating index system of the fire extinguishing system is established, and the subjective weight comparison of each index is determined. As shown in Embodiment I, Tables 2 and 3 are the scoring tables for the expert to score the subjective weight of the effectiveness of the fire extinguishing system.

According to a certain scale, for the relative importance of each index relative to other indexes, the evaluation judgment matrix U for the effectiveness of the converter substation fire extinguishing system is established, and the interaction between the index and other indexes is obtained.

The process of calculating the subjective weight vector includes: Based on the evaluation judgment matrix U for the effectiveness of the converter substation fire extinguishing system, the judgment matrix U is normalized by column by using a formula

$${\overline{u}}_{ij} = \frac{{u}_{ij}}{{\sum }_{k = 1}^{n} {u}_{kj}} , ( i , j = 1 , 2 , … n )$$

to obtain a matrix Ū=[ū₁ⱼ, ū₂ⱼ, . . . , ūₙⱼ]. uᵢⱼ represents the influence of the i^{th} factor on the j^{th} factor.

The normalized judgment matrix Ū is added by row by using a formula

$${\overline{W}}_{i} = {\sum }_{j = 1}^{n} {\overline{u}}_{ij} , ( i , j = 1 , 2 , … n ) .$$

The matrix W̅ᵢ added by row is normalized by using a formula

$${w}_{ij} = \frac{{\overline{W}}_{i}}{{\sum }_{j = 1}^{n} {\overline{W}}_{j}} , ( i = 1 , 2 , … n )$$

to obtain a row vector W=(w₁, w₂, . . . , wₙ)^{T}, where W=(w₁, w₂, . . . , wₙ)^{T} denotes the weight vector requested.

The process of the consistency test of the expert matrix includes:

A maximum eigenvalue λₘₐₓ of an expert judgment matrix and an expert weighting matrix is calculated. According to the maximum eigenvalue, the consistency test index of the expert judgment matrix is calculated by using a formula

$$CI = \frac{{λ}_{max} - n}{n - 1} ,$$

where n denotes an order of the matrix.

If the consistency test index is less than a set value, the expert judgment matrix is judged to meet the requirements and pass the consistency test.

If the consistency test index is not less than the set value, the expert judgment matrix is judged to not pass the consistency test, and the value of the elements in the expert judgment matrix should be continuously adjusted until the expert judgment matrix passes the consistency test.

In the EEM, the calculated subjective and objective weights are averaged to obtain the final comprehensive weight vector, which is expressed as W=[w₁, w₂, . . . , wₙ]^{⋅}. A point multiplication between the de-fuzzified matrix V and the comprehensive weight vector W is performed to obtain the final evaluation score. The effectiveness level of the fire extinguishing system is determined. If the effectiveness meets the requirements, the evaluation is complete. If the effectiveness does not meet the requirements, the rectification according to the solution measures and management suggestions put forth by the evaluation conclusions is performed. After the rectification is completed, the re-evaluation is performed until the evaluation result is acceptable, which will complete the comprehensive evaluation of the effectiveness of the transformer fire extinguishing system.

The above embodiments are only used to illustrate the technical solutions of the present invention and do not limit the present invention. Although the present invention is described in detail with reference to the embodiments, the ordinary person skilled in the art should understand that they can still modify the technical solutions disclosed in the embodiments or conduct equivalent replacement of some of the technical features. These modifications or replacements do not deviate from the essence of the corresponding technical solution or the spirit and scope of the technical solutions of the embodiments of the present invention.

What is claimed is:

1. A method for evaluating an effectiveness of a transformer fire extinguishing system based on a natural language fuzzy analysis, comprising the following steps:
step 1: collecting information, comprising collecting design and operation information, surrounding environment information, and transformer fire extinguishing system information of a substation, wherein the information collected at least comprises design parameters of the transformer fire extinguishing system, equipment operation data, maintenance, a substation construction environment, and others;
step 2: constructing an effectiveness-evaluating index system of the transformer fire extinguishing system, comprising classifying factors and constructing the effectiveness-evaluating index system for the transformer fire extinguishing system together with the factors, wherein the factors affect the effectiveness of the transformer fire extinguishing system;
step 3: establishing an index database, comprising configuring the effectiveness-evaluating index system as a candidate database and compiling an evaluation table and a voice recognition database based on the candidate database, wherein the evaluation table is configured for an expert to score directly, and the voice recognition database is configured for the expert to input a voice directly;
step 4: establishing an index natural language evaluation level, comprising determining a natural language evaluation level of the effectiveness-evaluating index system of the transformer fire extinguishing system, configuring the natural language evaluation level as a voice evaluation level, expressing each voice evaluation level by a fuzzy number, and establishing a voice evaluation level database;
step 5: inputting an evaluation result by the expert, wherein an input of the evaluation result comprises the following two modes: (1) configuring a form of text, comprising logging in to a WeChat mini program by the expert, initiating the input of the evaluation result, obtaining the evaluation table, writing the evaluation result into the evaluation table as required to submit, accepting the evaluation result in the evaluation table by the transformer fire extinguishing system, and establishing an expert fuzzy evaluation matrix; (2) configuring a voice mode, comprising configuring a voice broadcast score item of the WeChat mini program, sending voice evaluation contents according to prompts by the expert, obtaining voice data by the WeChat mini program, performing a voice recognition based on a voice database, receiving a preset voice input by the transformer fire extinguishing system to trigger evaluation indexes corresponding to the preset voice input, endowing recognition results with the evaluation indexes corresponding to the preset voice input, and establishing the expert fuzzy evaluation matrix;
step 6: determining an objective weight of an index, comprising de-fuzzifying the expert fuzzy evaluation matrix to obtain an index scoring matrix and determining an objective size of an index weight by an entropy weight method based on the index scoring matrix to obtain objective weights of different indexes;
step 7: establishing an index subjective weight scoring database, comprising establishing a subjective weight scoring table, determining a weight comparison of each index by the expert according to a relative influence of each index in the effectiveness-evaluating index system of the transformer fire extinguishing system, inputting a relative weight between the indexes, and establishing a subjective weight judgment matrix; wherein an input of a subjective weight comprises the following two modes: (1) configuring the form of text, comprising logging in to the WeChat mini program by the expert, initiating the input of the evaluation result, obtaining the evaluation table, writing the evaluation result into the evaluation table as required to submit, accepting the evaluation result in the evaluation table by the transformer fire extinguishing system, and establishing the subjective weight judgment matrix; (2) configuring the voice mode, comprising configuring the voice broadcast score item of the WeChat mini program, sending the voice evaluation contents according to the prompts by the expert, obtaining the voice data by the WeChat mini program, performing the voice recognition based on the voice database, receiving the preset voice input by the transformer fire extinguishing system to trigger the evaluation indexes corresponding to the preset voice input, endowing the recognition results with the evaluation indexes corresponding to the preset voice input, and establishing the subjective weight judgment matrix;
step 8: determining the index subjective weight, comprising performing a consistency test of the subjective weight judgment matrix based on an establishment of an index relative weight judgment matrix; if the subjective weight judgment matrix does not pass the consistency test, re-scoring and re-evaluating by the expert until the subjective weight judgment matrix passes the consistency test; calculating the subjective weight judgment matrix to obtain subjective weights of different indexes, wherein the subjective weight judgment matrix passed the consistency test; and
step 9: evaluating the effectiveness of the transformer fire extinguishing system, comprising performing a comprehensive evaluation based on an effectiveness index, performing a comprehensive evaluation according to the index scoring matrix and an average of a subjective weight vector and an objective weight vector, and determining an effectiveness level of the transformer fire extinguishing system; if the effectiveness meets requirements, completing the comprehensive evaluation; if the effectiveness does not meet the requirements, performing a rectification according to solution measures and management suggestions, wherein the solution measures and the management suggestions are put forward by evaluation conclusions; and after the rectification is completed, performing a re-evaluation until an evaluation result is acceptable.

2. The method according to claim 1, wherein in step 4, the process of establishing an index natural language evaluation level database comprises: establishing an evaluation set according to an evaluation system; using five evaluation languages, wherein the five evaluation languages comprises “excellent,” “good,” “general,” “poor,” and “very poor,” and recording an evaluation language level as L4-L0 in turn; expressing and describing the evaluation set by natural language fuzzy numbers, and setting the evaluation set as V={excellent, good, general, poor, very poor}; supposing that M experts are involved in the evaluation of the effectiveness of the transformer fire extinguishing system, and a k^{th} expert of the M experts evaluates an i^{th} evaluation index as an evaluation level value xᵢₖ; performing a natural language fuzzification on the effectiveness of the evaluation index of the transformer fire extinguishing system, wherein a natural language fuzzifying function ƒ(xᵢₖ) is:
$$f ( {x}_{ik} ) = \{ \begin{matrix}\frac{{x}_{ik} - l}{m - l} & {x}_{ik} ∈ [ l , m ] \\ \frac{u - {x}_{ik}}{u - m} & {x}_{ik} ∈ [ m , u ] \\ 0 & {x}_{ik} ∈ ( - ∞ , l ) ⋃ ( u , + ∞ )\end{matrix}$$
wherein the function ƒ(xᵢₖ) represents the natural language fuzzifying function of the k^{th} expert to the i^{th} evaluation index; supposing a language level evaluation fuzzy matrix of the k^{th} expert to the evaluation index to be V=[νᵢₖ], wherein the natural language fuzzifying function is νᵢₖ=(νᵢₖ₁, νᵢₖ₂, νᵢₖ₃) in form; and obtaining ν̅ᵢₖ=(ν̅ᵢₖ₁, ν̅ᵢₖ₂, ν̅ᵢₖ₃) by averaging the expert fuzzy evaluation matrices.

3. The method according to claim 1, wherein step 6 comprises: de-fuzzifying a fuzzy comprehensive evaluation system of the effectiveness of the transformer fire extinguishing system by using a formula of
$${F}_{3} ( V ) = \frac{{v}_{1} + 2 {v}_{2} + {v}_{3}}{4}$$
to obtain a de-fuzzified evaluation matrix V of the comprehensive evaluation of the effectiveness of the transformer fire extinguishing system; obtaining an information entropy by using a formula
$${e}_{i} = - \frac{1}{ln n} {\sum }_{j = 1}^{n} ( \frac{{b}_{ij}}{{\sum }_{j = 1}^{n} {b}_{i}} ) ln ( \frac{{b}_{ij}}{{\sum }_{j = 1}^{n} {b}_{i}} )$$
based on the de-fuzzified evaluation matrix V, wherein eᵢ denotes the information entropy, and bᵢ denotes a de-fuzzified evaluation value of the index; and
obtaining an entropy weight and a row vector W_{β}=(w₁, w₂, . . . , wₙ)^{T} by using a formula
$${w}_{i} = \frac{1 - {e}_{i}}{m - {\sum }_{i = 1}^{m} {e}_{i}} ,$$
wherein denotes the entropy weight, and the W_{β}=(w₁, w₂, . . . , wₙ)^{T} denotes an objective entropy weight vector.

4. The method according to claim 1, wherein in step 7, according to each index in the effectiveness of the transformer fire extinguishing system, the process of obtaining an interaction between the index and other indexes comprises: establishing an evaluation judgment matrix U for the effectiveness of the transformer fire extinguishing system according to a relative importance of the index to the other indexes by a predetermined scale, obtaining the interaction between the index and the other indexes, inputting relative weights between the indexes by the expert, and establishing the subjective weight judgment matrix, wherein the subjective weight judgment matrix is shown such as Table 1,
TABLE 1
subjective weight judgment matrix

| Uᵢ | U₁ | U₁ | . . . | U₁ₙ |
|---|---|---|---|---|
| U₁ | u₁₁ | u₁₂ | . . . | u₁ₙ |
| U₂ | u₂₁ | u₂₂ | . . . | u₂ₙ |
| . . . | . . . | . . . | . . . | . . . |
| Uₙ | uₙ₁ | uₙ₂ | . . . | uₙₙ |

5. The method according to claim 1, wherein in step 8, the process of calculating the subjective weight vector comprises: normalizing the evaluation judgment matrix U by column by using a formula
$${\overline{u}}_{ij} = \frac{{u}_{ij}}{{\sum }_{k = 1}^{n} {u}_{kj}} , ( i , j = 1 , 2 , … n )$$
based on the evaluation judgment matrix U for the effectiveness of the transformer fire extinguishing system to obtain a normalized evaluation judgment matrix Ū=[ū₁ⱼ, ū₂ⱼ, . . . , ūₙⱼ], wherein uᵢⱼ represents an influence of an i^{th} factor of the factors on an j^{th} factor of the factors;
adding the normalized evaluation judgment matrix Ū by row by using a formula
$${\overline{W}}_{i} = {\sum }_{j = 1}^{n} {\overline{u}}_{ij} , ( i , j = 1 , 2 , … n )$$
to obtain a matrix W̅ᵢ;
normalizing the matrix W̅ᵢ added by row by using a formula
$${w}_{i} = \frac{{\overline{W}}_{i}}{{\sum }_{j = 1}^{n} {\overline{W}}_{j}} , ( i = 1 , 2 , … n )$$
to obtain a row vector W_{α}=(w₁, w₂, . . . , wₙ)^{T}, W_{α}=(w₁, w₂, . . . , wₙ)^{T} denotes the subjective weight vector.

6. The method according to claim 5, wherein in step 8, the process of the consistency test of the subjective weight judgment matrix comprises: calculating a maximum eigenvalue λₘₐₓ of an expert judgment matrix and an expert weighting matrix; calculating a consistency test index of the expert judgment matrix by using a formula
$$CI = \frac{{λ}_{max} - n}{n - 1}$$
according to the maximum eigenvalue, wherein n denotes an order of the expert judgment matrix; if the consistency test index is less than a set value, judging the expert judgment matrix to meet the requirements and pass the consistency test; if the consistency test index is greater than or equal to the set value, judging the expert judgment matrix to not pass the consistency test and continuing to adjust a value of elements in the expert judgment matrix until the expert judgment matrix passes the consistency test.

7. The method according to claim 1, wherein step 9 comprises: averaging the subjective weight and the objective weight to obtain a comprehensive weight vector, wherein the comprehensive weight vector is expressed as W=[w₁, w₂, . . . , wₙ]^{⋅}; performing a point multiplication between the de-fuzzified evaluation matrix V and the comprehensive weight vector W to obtain an evaluation score; determining an effectiveness level of the transformer fire extinguishing system; if the effectiveness meets the requirements, completing the comprehensive evaluation; if the effectiveness does not meet the requirements, performing the rectification according to the solution measures and the management suggestions, wherein the solution measures and the management suggestions are put forward by the evaluation conclusions; and after the rectification is completed, performing the re-evaluation until the evaluation result is acceptable.

8. A device for evaluating an effectiveness of a transformer fire extinguishing system based on a natural language fuzzy analysis, comprising:
an index system establishment module (ISEM) for the effectiveness of the transformer fire extinguishing system, wherein the ISEM is configured for: selecting factors, wherein the factors affect the effectiveness of the transformer fire extinguishing system, and establishing an effectiveness-evaluating index system of the transformer fire extinguishing system; configuring the effectiveness-evaluating index system as a candidate database and compiling an evaluation table and a voice recognition database based on the candidate database; and determining a natural language evaluation level of the effectiveness-evaluating index system of the transformer fire extinguishing system, configuring the natural language evaluation level as a voice evaluation level, expressing each voice evaluation level by a fuzzy number, and establishing a voice evaluation level database;
an index scoring module (ISM) for an effectiveness, wherein the ISM is configured for: inputting an evaluation result of the index and a subjective weight judgment matrix by an expert, wherein an input of the evaluation result comprises the following two modes: (1) configuring a form of text, comprising logging in to a WeChat mini program by the expert, initiating the input of the evaluation result, obtaining the evaluation table, writing the evaluation result into the evaluation table as required to submit, accepting the evaluation result in the evaluation table by the transformer fire extinguishing system, and establishing an expert fuzzy evaluation matrix; (2) configuring a voice mode, comprising configuring a voice broadcast score item of the WeChat mini program, sending voice evaluation contents according to prompts by the expert, obtaining voice data by the WeChat mini program, performing a voice recognition based on a voice database, receiving a preset voice input by the transformer fire extinguishing system to trigger evaluation indexes corresponding to the preset voice input, endowing recognition results with the evaluation indexes corresponding to the preset voice input, and establishing the expert fuzzy evaluation matrix;
an index comprehensive weight calculation module (IWCM) for the effectiveness, wherein the IWCM is configured for: determining a subjective weight of each index and an objective weight of each index in the effectiveness-evaluating index system of the transformer fire extinguishing system, wherein de-fuzzifying the expert fuzzy evaluation matrix, determining an objective size of an index weight by using an entropy weight method to obtain objective weights of different indexes, determining a subjective weight comparison of each index according to a relative influence of each index, obtaining the subjective weight judgment matrix of a relative importance according to a correlation of indexes, performing a consistency test of the subjective weight judgment matrix, and after the subjective weight judgment matrix passes the consistency test, performing a calculation according to the subjective weight and the objective weight to obtain comprehensive weights of the different indexes; and
an effectiveness-evaluating module (EEM) for a fire extinguishing, wherein the EEM is configured for: evaluating the effectiveness of the transformer fire extinguishing system according to an index scoring matrix and the comprehensive weight; determining an effectiveness level of the transformer fire extinguishing system; according to the evaluation result, if the effectiveness meets requirements, completing a comprehensive evaluation; if the effectiveness does not meet the requirements, performing a rectification according to solution measures and management suggestions, wherein the solution measures and the management suggestions are put forward by evaluation conclusions; and after the rectification is completed, performing a re-evaluation by returning to step 3 until the evaluation result is acceptable.

9. The device according to claim 8, wherein:
in the ISM, the process of establishing the expert fuzzy evaluation matrix comprises: establishing an evaluation set according to an evaluation system; using five evaluation languages: “excellent,” “good,” “general,” “poor,” and “very poor,” and recording an evaluation language level as L4-L0 in turn; performing a natural language fuzzification on the effectiveness of the evaluation index of the transformer fire extinguishing system, and a natural language fuzzifying function ƒ(xᵢₖ) is:
$$f ( {x}_{ik} ) = \{ \begin{matrix}\frac{{x}_{ik} - l}{m - l} & {x}_{ik} ∈ [ l , m ] \\ \frac{u - {x}_{ik}}{u - m} & {x}_{ik} ∈ [ m , u ] \\ 0 & {x}_{ik} ∈ ( - ∞ , l ) ⋃ ( u , + ∞ )\end{matrix}$$
wherein the natural language fuzzifying function ƒ(xᵢₖ) represents a natural language fuzzifying function of a k^{th} expert to an i^{th} evaluation index;
wherein in the EEM, a language level evaluation fuzzy matrix of the k^{th} expert to the i^{th} evaluation index is supposed to be V=[νᵢₖ], wherein the natural language fuzzifying function is νᵢₖ=(νᵢₖ₁, νᵢₖ₂, νᵢₖ₃) in form, and the expert fuzzy evaluation matrices are averaged to obtain ν̅ᵢₖ=(ν̅ᵢₖ₁, ν̅ᵢₖ₂, ν̅ᵢₖ₃).

10. The device according to claim 8, wherein in the IWCM, a fuzzy comprehensive evaluation system of the effectiveness of the transformer fire extinguishing system is de-fuzzified by using a formula of
$${F}_{3} ( V ) = \frac{{v}_{1} + 2 {v}_{2} + {v}_{3}}{4}$$
to obtain a de-fuzzified evaluation matrix V of the comprehensive evaluation of the effectiveness of the transformer fire extinguishing system; an information entropy is obtained by using a formula
$${e}_{i} = - \frac{1}{ln n} {\sum }_{j = 1}^{n} ( \frac{{b}_{ij}}{{\sum }_{j = 1}^{n} {b}_{i}} ) ln ( \frac{{b}_{ij}}{{\sum }_{j = 1}^{n} {b}_{i}} )$$
based on the de-fuzzified evaluation matrix, wherein eᵢ denotes the information entropy, and bᵢ denotes a de-fuzzified evaluation value of the index; an entropy weight and a vector W_{β}=(w₁, w₂, . . . , wₙ)^{T} are obtained by using a formula
$${w}_{i} = \frac{1 - {e}_{i}}{m - {\sum }_{i = 1}^{m} {e}_{i}} ,$$
wherein wᵢ denotes the objective weight, W_{β}=(w₁, w₂, . . . , wₙ)^{T} denotes an objective weight vector;
wherein in the IWCM, the process of calculating a subjective weight vector comprises: normalizing an evaluation judgment matrix U by column by using a formula
$${\overline{u}}_{ij} = \frac{{u}_{ij}}{{\sum }_{k = 1}^{n} {u}_{kj}} , ( i , j = 1 , 2 , … n )$$
based on the evaluation judgment matrix U for the effectiveness of the transformer fire extinguishing system to obtain a normalized evaluation judgment matrix Ū=[ū₁ⱼ, ū₂ⱼ, . . . , ūₙⱼ], wherein uᵢⱼ represents an influence of an i^{th} factor on an j^{th} factor;
adding the normalized evaluation judgment matrix Ū by row by using a formula
$${\overline{W}}_{i} = {\sum }_{j = 1}^{n} {\overline{u}}_{ij} , ( i , j = 1 , 2 , … n )$$
to obtain a matrix W̅ᵢ; normalizing the matrix W̅ᵢ added by row by using a formula
$${w}_{i} = \frac{{\overline{W}}_{i}}{{\sum }_{j = 1}^{n} {\overline{W}}_{j}} , ( i = 1 , 2 , … n )$$
to obtain a row vector W=(w₁, w₂, . . . , wₙ)^{T}, wherein W=(w₁, w₂, . . . , wₙ)^{T} denotes the subjective weight vector.

11. The device according to claim 8, wherein a risk assessment in the EEM comprises:
averaging the subjective weight and the objective weight to obtain a comprehensive weight vector, wherein the comprehensive weight vector is expressed as W=[w₁, w₂, . . . , wₙ]^{⋅}; performing a point multiplication between a de-fuzzified evaluation matrix V and the comprehensive weight vector W to obtain an evaluation score; determining the effectiveness level of the transformer fire extinguishing system; if the effectiveness meets the requirements, completing the comprehensive evaluation; if the effectiveness does not meet the requirements, performing the rectification according to the solution measures and the management suggestions, wherein the solution measures and the management suggestions are put forward by the evaluation conclusions; after the rectification is completed, performing the re-evaluation until the evaluation result is acceptable; and completing the comprehensive evaluation of the effectiveness for the transformer fire extinguishing system.
